(19) United States
(12) Patent Application Publication
(10) Pub. No.: US 2004/0227344 A1
(43) Pub. Date: Nov. 18, 2004

(54) Hose coupling devie

(76) Inventor: Tung Yi Lin, Taichung (TW)

Correspondence Address: Tung Yi Lin, P.O. Box 63-99, Taichung, 406, TW

(21) Appl. No.: 10/841,887

(22) Filed: May 7, 2004

(30) Foreign Application Priority Data
May 16, 2003 (TW) 92208996

(51) Int. Cl. F16L 17/00

(52) U.S. Cl. 285/256; 285/259

(57) ABSTRACT

A hose coupling device includes a flexible hose member having a bore formed by an inner peripheral surface, and having one or more longitudinal ribs extended into the bore, for engaging with the inner peripheral surface of the hose member, and for preventing the bore of the hose member from being completely blocked, and for allowing water to flow through the bore of the hose member even when the hose member is twisted. A coupler may be coupled to water reservoir and includes a mouth engageable into the hose member. The coupler includes one or more longitudinal grooves to receive the longitudinal ribs of the hose member, and to anchor the hose member to the mouth of the coupler.

### BACKGROUND OF THE INVENTION

1. Field of the Invention

The present invention relates to a hose coupling device, and more particularly to a hose coupling device having an improved structure to prevent the water passage of the hose member from being completely blocked, and to allow the water to flow through the hose member, particularly when the hose member is twisted.

2. Description of the Prior Art

Typical hose coupling devices comprise a flexible and tubular hose member for coupling or attaching to a faucet, to receive water from the faucet.

Normally, the hose member is made of flexible and tubular rubber materials, and may be wound and received as a reel, for storing and transportation purposes.

However, due to the flexibility of the rubber hose member, the water passage within the hose member may be completely blocked particularly when the hose is twisted, such that the water may have a good chance to be blocked within the hose member, and thus may not smoothly flow through the hose member.

The present invention has arisen to mitigate and/or obviate the afore-described disadvantages of the conventional hose coupling devices.

### SUMMARY OF THE INVENTION

The primary objective of the present invention is to provide a hose coupling device including an improved structure to prevent the water passage of the hose member from being completely blocked, and to allow the water to flow through the hose member, particularly when the hose member is twisted.

In accordance with one aspect of the invention, there is provided a hose coupling device comprising a flexible hose member including a bore formed therein and defined by an inner peripheral surface, and provided as a water passage, and the hose member including at least one longitudinal rib extended into the bore thereof, for engaging with the inner peripheral surface of the hose member, and for preventing the bore of the hose member from being completely blocked, and for allowing water to flow through the bore of the hose member even when the hose member is twisted.

The hose member includes at least one longitudinal protuberances extended outwardly therefrom, for increasing a bending strength of the hose member.

A coupler may further be provided for coupling to water reservoir, the coupler includes a mouth extended therefrom and engageable into a first end of the hose member, for coupling the hose member to the mouth of the coupler.

The coupler includes at least one longitudinal groove formed therein, to receive the longitudinal rib of the hose member, and to anchor and secure the hose member to the mouth of the coupler, and to prevent the hose member from being rotated relative to the mouth of the coupler.

The coupler includes at least one outer peripheral recess formed therein, the first end of the hose member is engageable into the outer peripheral recess of the coupler, to anchor the hose member to the mouth of the coupler.

A forcing device may further be provided for forcing the first end of the hose member against the mouth of the coupler, to stably secure the hose member to the mouth of the coupler.

The forcing device includes an outer sleeve engaged onto the first end of the hose member, to force and clamp the first end of the hose member onto the mouth of the coupler, and to stably secure the hose member to the mouth of the coupler.

The coupler includes an outer thread provided thereon, and a lock nut engaged onto the outer sleeve, to force the first end of the hose member onto the mouth of the coupler, to solidly clamp and secure the hose member to the coupler.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a hose coupling device in accordance with the present invention;

FIG. 2 is a partial perspective view of the hose coupling device;

FIG. 3 is a partial cross sectional view of the hose coupling device, taken along lines 3-3 of FIG. 2;

FIG. 4 is a partial cross sectional view of the hose coupling device, taken along lines 4-4 of FIG. 2;

FIG. 5 is a partial cross sectional view similar to FIG. 4, illustrating the operation of the hose coupling device;

FIG. 6 is a partial perspective view illustrating a twisting status of the hose coupling device; and

FIG. 7 is a partial exploded view similar to FIG. 1, illustrating the other arrangement of the hose coupling device.

### DETAILED DESCRIPTION OF THE PREFERRED EMBODIMENT

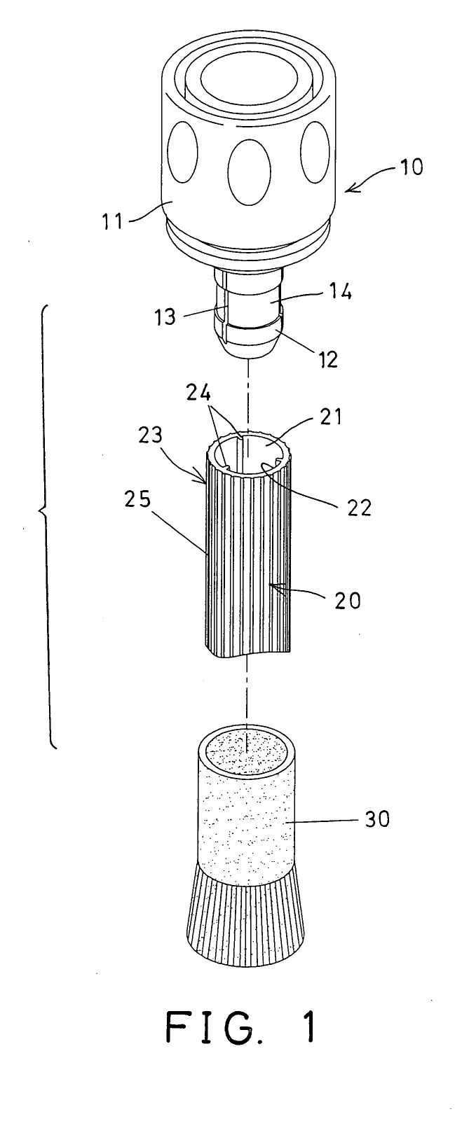

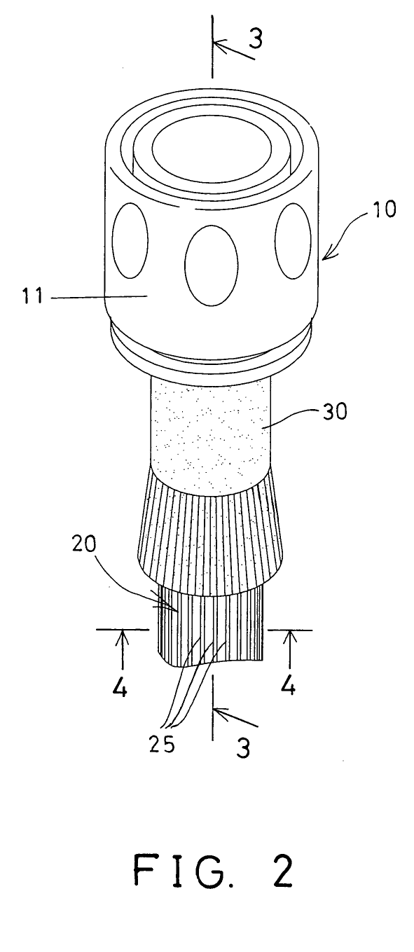

Referring to the drawings, and initially to FIGS. 1-4, a hose coupling device in accordance with the present invention comprises a connector 10 including a coupler 11 for coupling to water reservoirs via nozzles or faucets (not shown) or the like, The coupler 11 including a tubular mouth 12 extended therefrom, and having one or more longitudinal grooves 13 formed therein, and one or more outer peripheral recesses 14 formed therein.

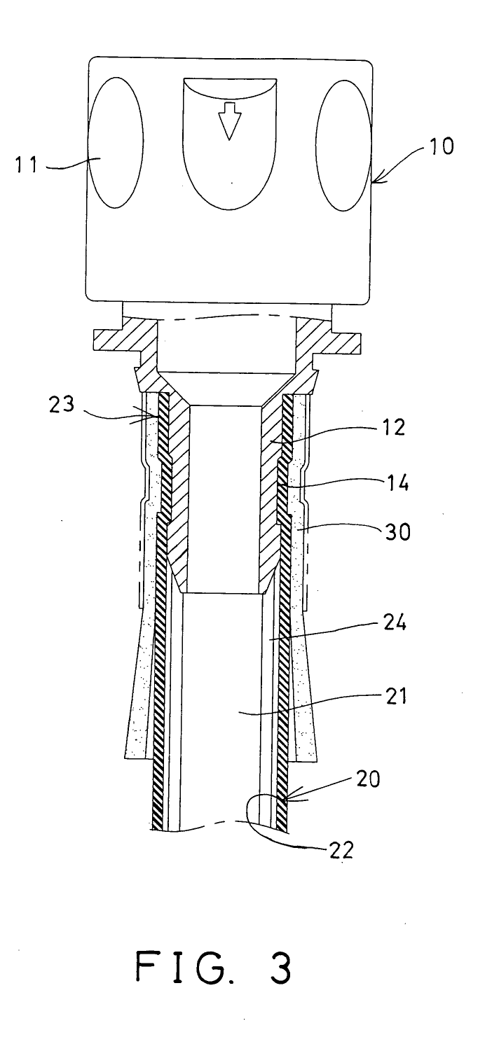

A flexible hose member 20 including a bore 21 formed therein and defined by an inner peripheral surface 22, and provided as a water passage, for receiving the tubular mouth 12 of the coupler 11, and including one end 23 for attaching or securing onto the tubular mouth 12 of the coupler 11 with such as a force-fitted engagement, best shown in FIG. 3.

The hose member 20 including one or more longitudinal ribs 24 extended into the bore 21 thereof, for engaging into the longitudinal grooves 13 of the tubular mouth 12 or of the coupler 11, and thus for further stably anchoring or securing the hose member 20 to the tubular mouth 12 of the coupler 11, and for preventing the hose member 20 from being rotated relative to the tubular mouth 12 of the coupler 11.

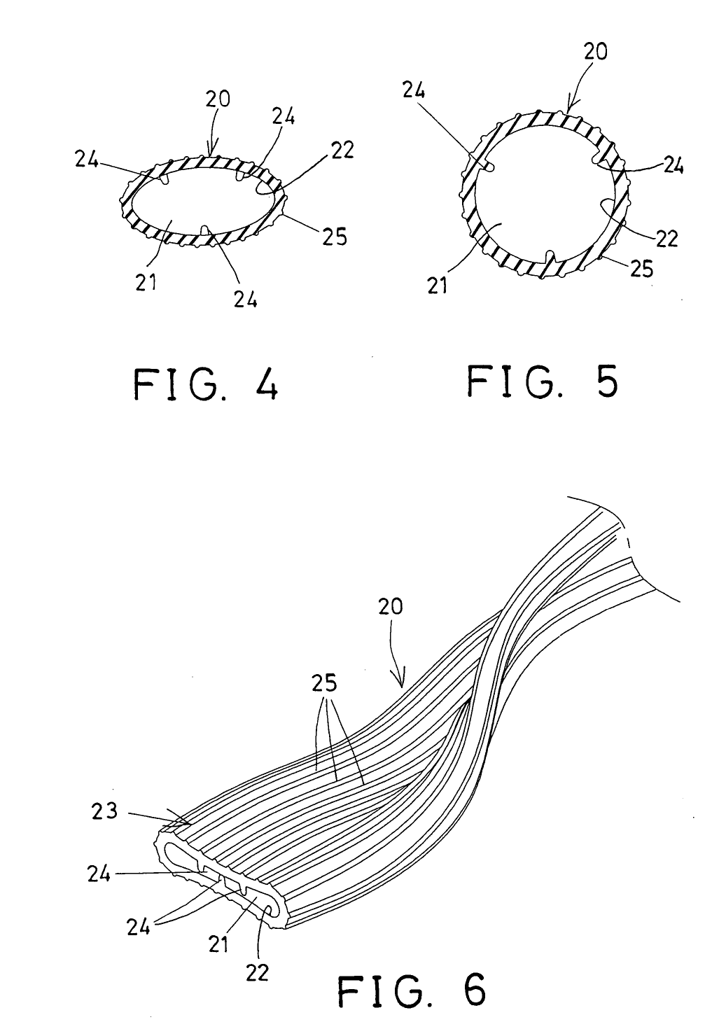

The hose member 20 further including one or more longitudinal protuberances 25 extended outwardly therefrom, for increasing the bending strength of the hose member 20, but also for maintaining the flexibility of the hose member 20. As shown in FIGS. 4 and 6, when no water flows through the bore 21 of the hose member 20, the hose member 20 may also be flattened for allowing the hose member 20 to be wound and received as a reel, for storing and transportation purposes.

In addition, as best shown in FIG. 6, when the hose member 20 is twisted, the longitudinal ribs 24 of the hose member 20 may be engaged with the inner peripheral surface 22 of the hose member 20, and may prevent the bore 21 of the hose member 20 from being completely blocked, and thus to allow the water to flow through the bore 21 of the hose member 20 even when the hose member 20 has been twisted or distorted to various shapes or configurations.

As shown in FIG. 5, when water has been supplied into the hose member 20 via the tubular mouth 12 of the coupler 11, the hose member 20 may also be suitably expanded by the water pressure within the hose member 20, due to the flexibility of the rubber materials of the hose member 20, to allow the water to flow through the hose member 20 in suitable flowing speed and in suitable flowing quantity.

As best shown in FIG. 3, a protective outer sleeve 30 may further be provided and engaged onto the one end 23 of the hose member 20, and may also be engaged onto the tubular mouth 12 of the coupler 11. The protective outer sleeve 30 is preferably made of rubber or resilient materials for forcing or clamping the one end 23 of the hose member 20 onto or against the tubular mouth 12 of the coupler 11, and thus for further stably securing the hose member 20 to the tubular mouth 12 of the coupler 11, and for preventing the hose member 20 from being disengaged from the tubular mouth 12 of the coupler 11.

As also best shown in FIG. 3, the protective outer sleeve 30 may force a portion of the one end 23 of the hose member 20 into the outer peripheral recesses 14 of the tubular mouth 12 of the coupler 11, to stably or solidly clamp or secure the hose member 20 to the coupler 11.

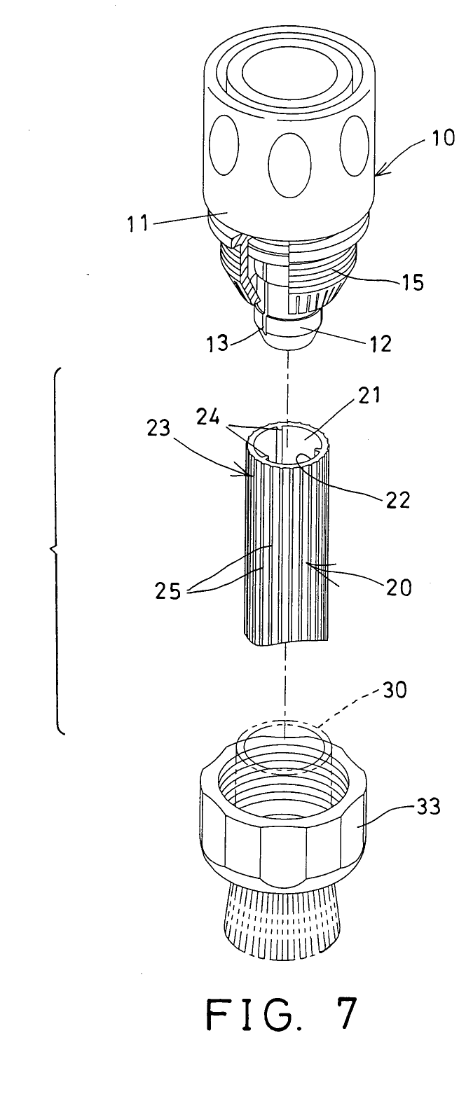

As shown in FIG. 7, the coupler 11 may further including an outer thread 15 formed or provided thereon, and a clamping or lock nut 33 may be engaged onto the protective outer sleeve 30 and/or the hose member 20, to further force or clamp the one end 23 of the hose member 20 onto the tubular mouth 12 of the coupler 11, to further stably or solidly clamp or secure the hose member 20 to the coupler 11.

It is to be noted that the formation or the provision or the extension of the longitudinal ribs 24 into the bore 21 of the hose member 20 may prevent the bore 21 of the hose member 20 from being completely blocked, and thus may allow the water to suitably flow through the bore 21 of the hose member 20 even when the hose member 20 has been twisted or distorted to various shapes or configurations.

Accordingly, the hose coupling device in accordance with the present invention including an improved structure to prevent the water passage of the hose member from being completely blocked, and to allow the water to flow through the hose member, particularly when the hose member is twisted.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A hose coupling device comprising:
a flexible hose member including a bore formed therein and defined by an inner peripheral surface, and provided as a water passage, and
said hose member including at least one longitudinal rib extended into said bore thereof, for engaging with said inner peripheral surface of said hose member, and for preventing said bore of said hose member from being completely blocked, and for allowing water to flow through said bore of said hose member even when said hose member is twisted.

2. The hose coupling device as claimed in claim 1, wherein said hose member includes at least one longitudinal protuberances extended outwardly therefrom, for increasing a bending strength of said hose member.

3. The hose coupling device as claimed in claim 1 further comprising a coupler for coupling to water reservoir, said coupler including a mouth extended therefrom and engageable into a first end of said hose member, for coupling said hose member to said mouth of said coupler.

4. The hose coupling device as claimed in claim 3, wherein said coupler includes at least one longitudinal groove formed therein, to receive said at least one longitudinal rib of said hose member, and to anchor and secure said hose member to said mouth of said coupler, and to prevent said hose member from being rotated relative to said mouth of said coupler.

5. The hose coupling device as claimed in claim 3, wherein said coupler includes at least one outer peripheral recess formed therein, said first end of said hose member is engageable into said at least one outer peripheral recess of said coupler, to anchor said hose member to said mouth of said coupler.

6. The hose coupling device as claimed in claim 3 further comprising means for forcing said first end of said hose member against said mouth of said coupler, to stably secure said hose member to said mouth of said coupler.

7. The hose coupling device as claimed in claim 6, wherein said forcing means includes an outer sleeve engaged onto said first end of said hose member, to force and clamp said first end of said hose member onto said mouth of said coupler, and to stably secure said hose member to said mouth of said coupler.

8. The hose coupling device as claimed in claim 7, wherein said coupler includes an outer thread provided thereon, and a lock nut engaged onto said outer sleeve, to force said first end of said hose member onto said mouth of said coupler, to solidly clamp and secure said hose member to said coupler.
